(19) United States
(12) Patent Application Publication
(10) Pub. No.: US 2012/0161919 A1
(43) Pub. Date: Jun. 28, 2012

(54) Safety Fuse Holder Assembly

(76) Inventor: Patrick A. von zur Muehlen, Springfield, MO (US)

(21) Appl. No.: 12/975,420

(22) Filed: Dec. 22, 2010

(51) Int. Cl. H01H 85/165

(52) U.S. Cl. 337/228

(57) ABSTRACT

A safety fuse holder assembly includes a retaining member. The retaining member is selectively configurable to retain the fuse in an interior space of a first fuse holder component such that the entirety of the fuse remains in the interior space when the first fuse holder component is removed from a second fuse holder component. The safety fuse holder may be IP 20 compliant.

### BACKGROUND OF THE INVENTION

The field of the invention relates generally to a safety fuse holder assembly.

Fuses are widely used as overcurrent protection devices to prevent costly damage to electrical circuits. Fuse terminals typically form an electrical connection between an electrical power source and an electrical component or a combination of components arranged in an electrical circuit. One or more fusible links or elements, or a fuse element assembly, is connected between the fuse terminals, so that when electrical current through the fuse exceeds a predetermined limit, the fusible elements melt and open one or more circuits through the fuse to prevent electrical component damage.

A variety of different types of fuse holders are known to provide electrical interfaces for overcurrent protection fuses. One type of fuse holder is an inline fuse holder that electrically connects a ferrule fuse within an electrical system. The inline fuse holder assembly typically comprises a holder body having two pieces that releasably attach to one another and define an interior space for receiving the fuse. At least two contacts of the inline fuse electrically connect to the terminals of the fuse when the fuse is received in the fuse holder body. Among several applications, the inline fuse holder may be used in solar photovoltaic systems. In such an application, however, there is a risk that one or both of the contacts of the inline fuse holder or one or both ends of the fuse may be energized when the holder body is open. This leads to a risk of electric shock if a technician or other person does not first disconnect the fuse holder from the system at both contacts.

### BRIEF DESCRIPTION OF THE DRAWINGS

Non-limiting and non-exhaustive embodiments are described with reference to the following Figures, wherein like reference numerals refer to like parts throughout the various drawings unless otherwise specified.

FIG. 1 is a perspective of an embodiment of a safety fuse holder assembly.

FIG. 2 is an exploded view of the safety fuse holder assembly of FIG. 1, illustrating first and second components of the assembly.

FIG. 3 is a front elevation of the safety fuse holder assembly of FIG. 1.

FIG. 4 is a longitudinal section of the safety fuse holder assembly of FIG. 3 taken along the line 4-4.

FIG. 5 is an exploded view of the longitudinal section of the safety fuse holder assembly of FIG. 4.

FIG. 6 is a longitudinal section of the safety fuse holder assembly of FIG. 3, similar to FIG. 4, except that the safety fuse holder assembly is rotated 90 degrees about its longitudinal axis.

FIG. 7 is an exploded view of the longitudinal section of the safety fuse holder assembly of FIG. 6.

FIG. 8 is a cross section of the second component of the safety fuse holder assembly of FIG. 2 taken along the line 8-8.

FIG. 9 is a cross section of the second component of the safety fuse holder assembly of FIG. 2 taken along the line 9-9.

FIG. 10 is an enlarged view of the area indicated by numeral 10 in FIG. 6.

FIG. 11 is an enlarged view of the area indicated by numeral 11 in FIG. 7.

### DETAILED DESCRIPTION OF THE DRAWINGS

Referring now to drawings, one example of a safety fuse holder assembly is generally indicated at reference numeral 10. The fuse holder assembly 10 comprises first and second components, generally indicated at 12, 14, respectively, that are releasably connectable to one another to enclose a fuse 16 and electrically connect the enclosed fuse within an electrical circuit or electrical grid or other electrical device or system that requires a fuse, such as a solar photovoltaic system. The fuse 16, with which the illustrated safety fuse holder assembly 10 is configured for use, is of the type generally known as a ferrule fuse having ferrule terminals 18 at opposite longitudinal ends thereof. It is understood that the safety fuse holder assembly may be configured for use with another type of fuse, other than a ferrule fuse, without departing from the scope of the present invention. As explained in more detail below, the safety fuse holder assembly 10 is adapted to inhibit a person, more specifically a person's finger, from inadvertently making electrical contact with the fuse 16, particularly when the safety fuse holder assembly is open (i.e., when the first and second components 12, 14, respectively, are unconnected and separated from one another). The illustrated safety fuse holder assembly 10 is a one-pole, non-breakaway inline fuse holder assembly, although it is understood that the fuse holder assembly may be, among others, a breakaway type fuse holder assembly, and/or a multiple pole (e.g., double pole) fuse holder assembly.

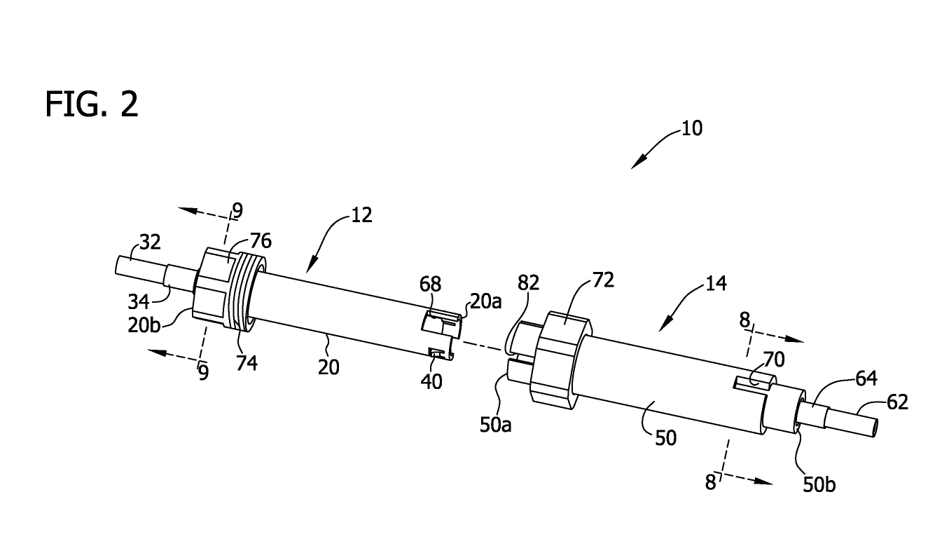

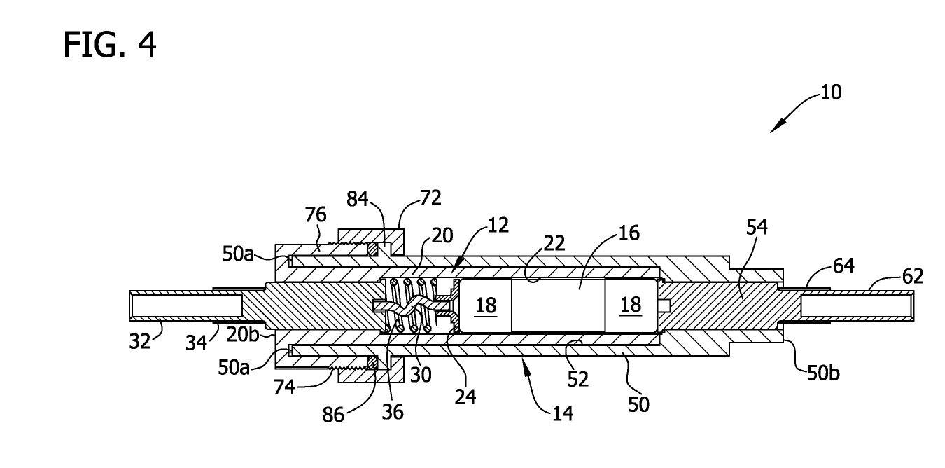

As seen best in FIGS. 2, 5, and 7, the first component 12 of the illustrated safety fuse holder assembly 10 includes a generally elongate, cylindrical body 20 having an open longitudinal end 20a, and an opposite, closed longitudinal end 20b. The body 20 may be of another suitable shape without departing from the scope of the present invention. Referring to FIGS. 4-7, the body 20 at least partially defines an interior space 22 extending longitudinally from the open longitudinal end 20a toward the closed longitudinal end 20b. As explained in more detail below, the open end 20a and the interior space 22 of the first component 12 are sized and shaped to slidably receive the fuse 16 in the interior space. The body 20 of the first component 12 may be formed from a suitable electrically insulating material, such as a suitable plastic material, and may be molded or constructed in other ways.

Referring to FIGS. 4-7, an electrical contact 24, which closes an end of the interior space 22 opposite the open longitudinal end 20a, is configured to make electrical connection with the corresponding ferrule terminal 18 of the fuse 16 when the fuse is secured in the fuse holder assembly 10. A shunt wire 30 electrically connects the electrical contact 24 to an electrical connector 32 secured at the closed longitudinal end 20b of the body 20. The electrical connector 32 is configured to electrically connect a wire or cable or other conductor (not shown) to the electrical contact 24, thereby electrically connecting the fuse 16 to the electrical system. An insulating sheath 34 surrounds at least a longitudinal portion of the electrical connector 32. As explained below, in one non-limiting embodiment it is envisioned that the first component 12 will be connected to the line side of the electrical system, although it may be connectable to the load side without departing from the scope of the present invention. The illustrated electrical connector 32 is configured to receive terminal ends of the cable and secure the terminal ends of the cable therein by crimping or in other ways. The first component 12 also includes a compression spring 36 between the electrical contact 24 and the electrically connector 32. The compression spring 36 urges the electrical contact 24 toward the open longitudinal end 20a of the body 20. The electrical contact 24 and the electrical connector 32 are electrically conductive and may include suitable electrically conductive metal or alloy known in the art. An additional insulating member (not shown), known in the art as an insulating boot, may be secured to the first component 12.

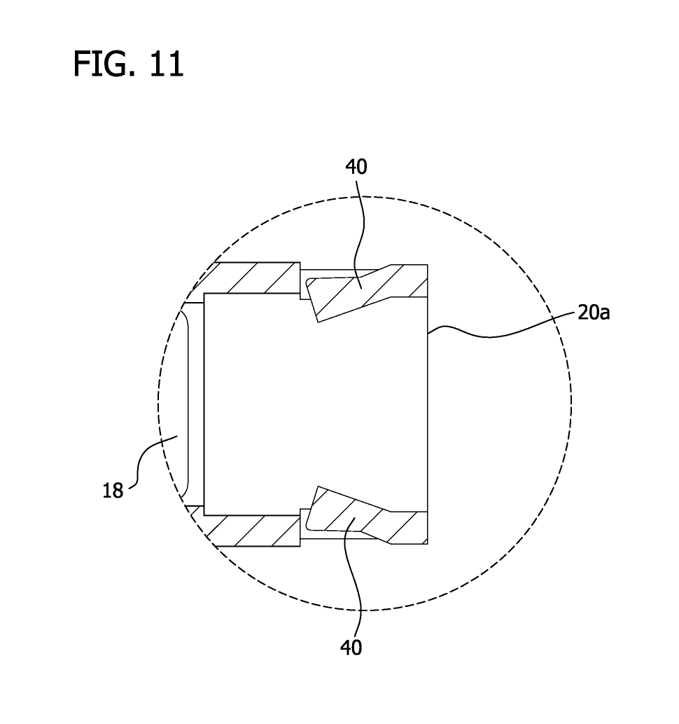

As set forth above, the open longitudinal end 20a and the interior space 22 of the first component 12 are sized and shaped so that the interior space can slidably receive the fuse 16 through the open longitudinal end 20a. In particular, the interior space 22 of the first component 12 is sized and shaped so that an entirety of the fuse 16 (i.e., its entire length) is receivable in the interior space. As seen best in FIGS. 2, 6, and 11, retaining members, such as a pair of retaining tabs 40, are provided adjacent to the open longitudinal end 20a of the cylindrical body 20 and are selectively extendable radially inward into the interior space 22. The retaining tabs 40 are configured to selectively restrict or limit relative longitudinal movement of the fuse 16 in the interior space 22 to substantially retain the entirety of the fuse 16 in the interior space when the first component is disconnected from the second component 14. That is, the retaining tabs 40 inhibit the ferrule terminal 18 of the fuse 16 from inadvertently projecting outward from the open longitudinal end 20a of the body 20 of the first component 12. The safety fuse holder assembly 10 may include one or more retaining members, and may include another suitable type of retaining member, other than the illustrated retaining tabs 40, at the same or different locations for restricting or limiting relative movement of the fuse 16 in the interior space, as set forth above, without departing from the scope of the present invention. Some non-limiting examples of other retaining members may include a ball detent, a spring-biased ball detent, a detent pin, a spring-based detent pin, and a friction detent, among other detents.

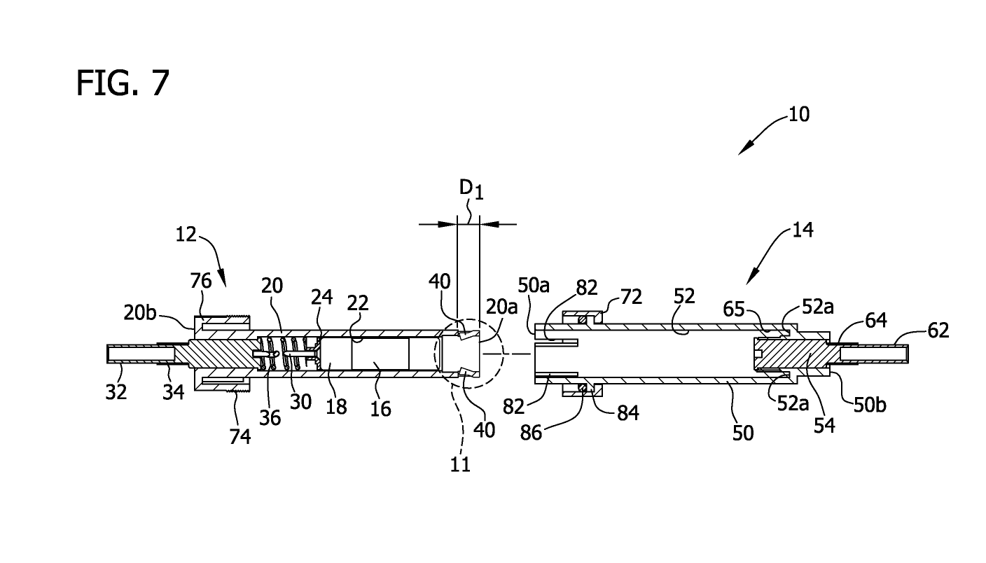

In the illustrated embodiment, the open longitudinal end 20a has an inner diameter that is less than 12 mm, in compliance with the IP 20 rating (i.e., finger-safe rating) according to the International Electrotechnical Commission (IEC). Moreover, in the illustrated embodiment the retaining tabs 40 retain the adjacent ferrule terminal 18 of the fuse 16 at a preselected distance D₁ (FIG. 7) from the open longitudinal end 20a for additional safety and to further inhibit a person's finger from inadvertently contacting the fuse terminal. In a non-limiting example, this preselected distance D₁ may be from about 1 mm (0.04 in) to about 10 mm (0.4 in), or greater.

The illustrated retaining tabs 40 are formed integrally with the body 20 of the first component 12, although the retaining tabs may be formed separately from the body and secured thereto by a suitable method. The retaining tabs 40 substantially diametrically oppose one another, and are hingedly secured to the body 20 by respective living hinges at the junctions of the respective tabs and the body. The living hinges allow the retaining tabs 40 to be selectively rotated or pivoted relative to the body 20 about an axis that is generally transverse to the body to position the tabs between a retaining position, in which the tabs inhibit the ferrule fuse 16 from sliding out of the second component to retain the entirety of the fuse in the interior chamber 22, and a non-retaining position, in which the tabs do not inhibit the longitudinal end of the corresponding ferrule terminal of the fuse 16 from projecting outward from the open longitudinal end of the body 20. As seen best in FIGS. 2, 5 and 7, in the retaining position, the tabs 40 extend at least partially into the interior space 22, and in the non-retaining position, the tabs may or may not extend into the interior space.

In a non-limiting example, the retaining tabs 40 are configured to substantially remain in a preselected one of the retaining position and the non-retaining position unless, or until, a suitable external force is imparted to the tabs. In other words, the user must apply a force to deflect or move the retaining tabs 40 from the non-retaining position into the retaining position, and must also apply an opposite force to deflect or move the retaining tabs from the retaining position into the non-retaining position. The tabs 40 may be configured such that portions of the tabs project outside the body 20 of the first component 12 even when the tabs are in the retaining position. Through this configuration, the user has access to the tabs 40 from outside the body 20 so that the user can deflect or pivot the tabs 40 using his/her finger or a suitable tool (e.g., a screwdriver or pliers).

In another non-limiting example, the retaining tabs 40 may be urged or resiliently biased into the retaining position. In such an example, the retaining tabs 40 are biased to extend into the interior chamber 22 and are configured to resiliently deflect outward relative to the interior chamber upon the leading ferrule terminal 18 of the fuse 16 contacting the tabs as the fuse 16 is inserted into the interior chamber. After the trailing ferrule terminal 18 has passed the tabs 40, the tabs will rebound or reflect back into the initial retaining position. The living hinges of the tabs 40 may be configured to facilitate the resilient biasing of the retaining tabs 40 or another device (e.g., a spring member) or another way of resiliently biasing the tabs may be provided.

The retaining tabs 40 may be formed as an integrally molded component of the body 20, such as when molding the body, or the retaining tabs may be formed by machining after the body is formed. Other ways of making the retaining tabs 40 and other configurations of the tabs do not depart from the scope of the present invention.

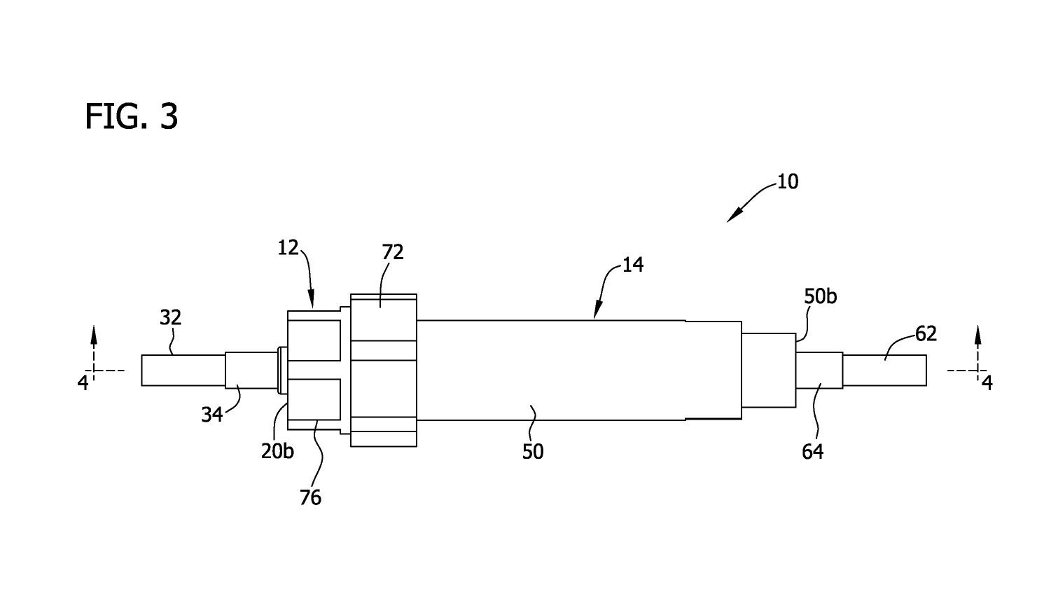

Referring to FIGS. 2-7, the second component 14 of the illustrated safety fuse holder assembly 10 includes a generally elongate, cylindrical body 50 having an open longitudinal end 50a, and an opposite, closed longitudinal end 50b. The body 50 may be of another suitable shape, and desirably one that is generally commensurate with the shape of the first component 12, without departing from the scope of the present invention. The body 50 at least partially defines an interior space 52 extending longitudinally from the open longitudinal end 50a to a closed end 52a (FIG. 7) of the interior space generally adjacent to the closed longitudinal end 50b of the body. As explained in more detail below, the open longitudinal end 50a and the interior space 52 of the second component 14 are sized and shaped to slidably receive the body 20 of the first component 12 therein. Accordingly, in the illustrated embodiment the first component 12 is configured as a male component of the safety fuse holder assembly 10, and the second component 14 is configured as a female component. The body 50 of the first component 15 may be formed from a suitable electrically insulating material, such as a suitable plastic material, and may be molded or constructed in other ways.

An electrical contact 54 within the interior space 52 is configured to make electrical connection with a ferrule terminal 18 of the fuse 16 when the fuse is secured in the fuse holder assembly 10. The electrical contact 54 is electrically connected to an electrical connector 62 secured at the closed longitudinal end 50b of the body 50, and may be formed integrally therewith. The electrical connector 62 is configured to electrically connect a wire or cable or other conductor (not shown) to the electrical contact 54, thereby electrically connecting the fuse 16 to the electrical system. As explained below, in an exemplary embodiment it is envisioned that the second component 14 will be connected to the load side of the electrical system, although it may be connectable to line side without departing from the scope of the present invention. The illustrated electrical connector 62 is configured to receive terminal ends of the cable and secure the terminal ends of the cable therein by crimping or in other ways. The electrical contact 54 and the electrical connector 62 are electrically conductive and may comprise suitable electrically conductive metal or alloy known in the art. An insulating sheath 64 surrounds at least a longitudinal portion of the electrical connector 32. An additional insulating member (not shown), known in the art as an insulating boot, may be securable to the second component 14.

As set forth above, the open longitudinal end 50a and the interior space 52 of the second component 14 are sized and shaped to slidably receive the body 20 of the first component 12 therein. The first and second components 12, 14 are configured relative to one another such that when the first component 12 is fully received in the second component 14 and the two components are connected together, the electrical contact 54 of the second component makes electrical connection with the corresponding ferrule terminal 18 of the fuse 16 that is received in the first component. More specifically, in the illustrated embodiment the electrical contact 54 of the second component 14 is receivable in the open longitudinal end 20a of the first component 12.

Referring to FIGS. 2, 7, and 8, arcuate clearance slots 65 (e.g., two) in the body 50 of the second component 14 extend partially around the circumference of the electrical contact 54, and clearance slots 68 extend longitudinally from the open end 20a of the body 20 of the first component 12. Together, the clearance slots 65, 68 allow the electrical contact 54 to move (e.g., slide) into the open longitudinal end 20 of the first component 12 so that the electrical contact 54 of the second component makes electrical connection with the corresponding ferrule terminal 18 of the fuse 16. The arcuate clearance slots 65 in the second component 14 receive the open longitudinal end 20a of the first component 12, and the clearance slots 68 in the first component 12 receive portions of the body 50 of the second component extending between the arcuate clearance slots. When the first and second components 12, 14 are assembled into the safety fuse holder assembly 10, the open longitudinal end 20a of the first component generally abuts the closed end 52a of the interior space 52 of the second component, the interior space 22 of the first component receives the electrical contact 54 of the second component, and the compression spring 36 in the first component 12 urges the fuse 16 into abutting, electrical contact with the electrical contact 54 of the second component. In one example, the clearance slots 68 have dimensions (i.e., length and width) that are less than 12 mm and are IP 20 compliant so that when the inner diameter of the open longitudinal end 20a is also less than 12 mm, the first component 12 is IP 20 compliant and finger-safe according to the International Electrotechnical Commission (IEC). Moreover, in the illustrated embodiment the clearance slots 68 and the body 20 of the first component 12 are configured such that when the fuse 16 is in electrical contact with the electrical contact 24 of the first component 12, the ferrule terminal 18 adjacent to the open longitudinal end 20a is longitudinally spaced from the clearance slots 68. In this way, when the fuse 16 is in electrical contact with the electrical contact 24 of the first component 12, the entire length of the fuse is enclosed in the first component.

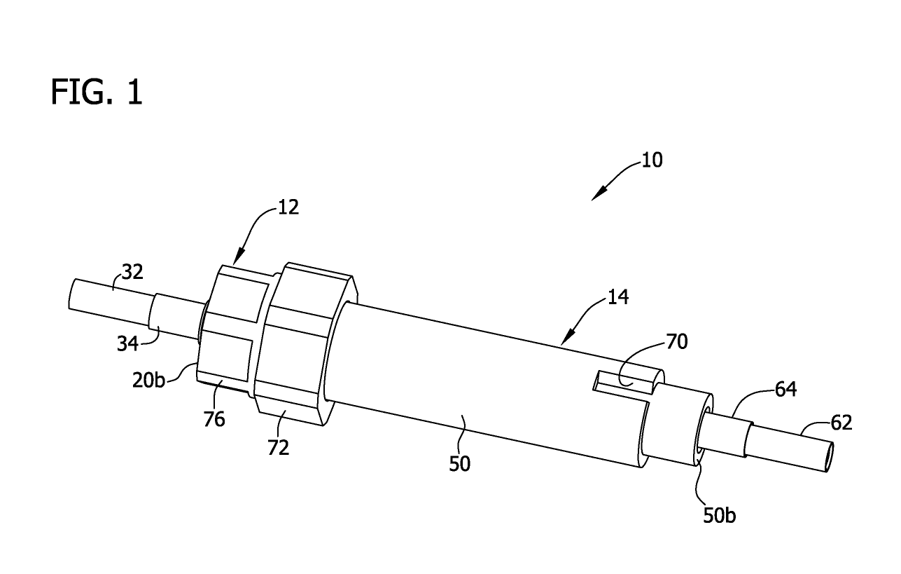

In the illustrated embodiment, the second component 14 has longitudinal slots 70 on the body 50 (FIGS. 1 and 2) to facilitate proper alignment of the first component 12 with the second component. The slots 70 on the second component 14 are radially aligned with the portions of the second component extending between the arcuate clearance slots 65. As such, the longitudinal slots 70 indicate to the user that the clearance slots 68 should be aligned longitudinally with the slots 70 when inserting the first component 12 into the second component so that the first and second components 12, 14 mate properly. In another suitable embodiment, the longitudinal slots 70 may be replaced with other types of indicators, such as one or more graphics or symbols on the second component 14. Other ways of facilitating proper alignment of the first and second components 12, 14 are possible and do not depart from the scope of the present invention. It is understood that the second component 14 may include a circumferential clearance slot that extends about an entirety of the electrical contact 54, whereby the first component 12 would not need clearance slots 68 or the longitudinal slots 70.

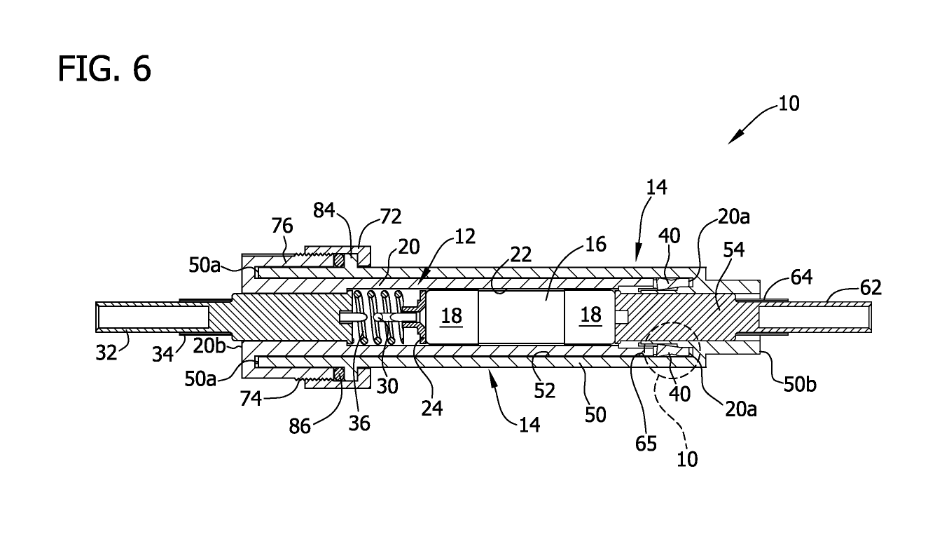

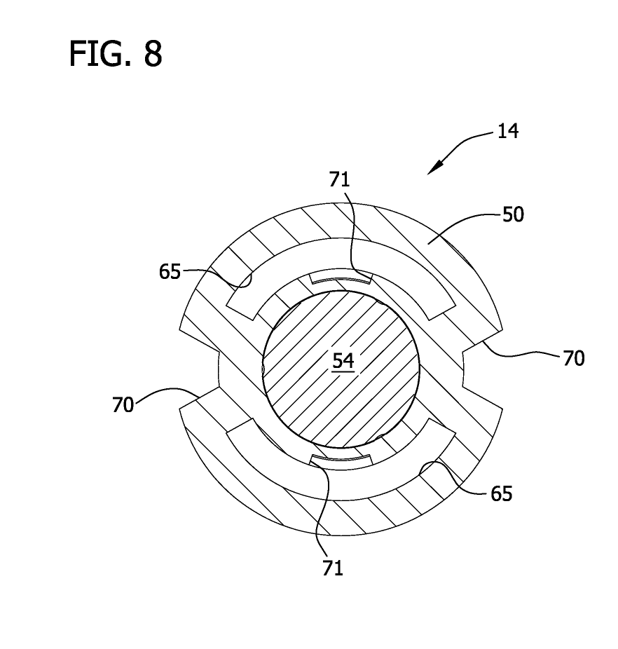

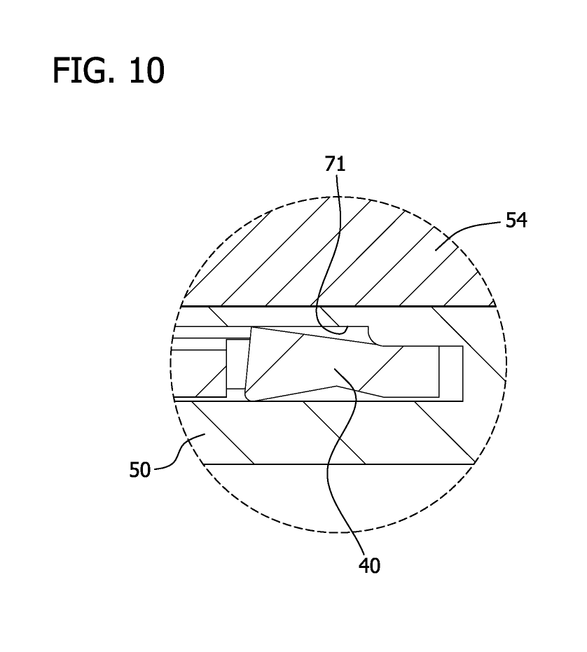

As seen in FIG. 6, the electrical contact 54 of the second component 14 slides past the retaining tabs 40 as the electrical contact is received in the interior chamber 22 of the first component 12. In the illustrated embodiment, the retaining tabs 40 remain in the retaining position upon insertion of the electrical contact 54 into the first component 12, although the fuse 16 is moved away from the tabs, against the force of the compression spring 36 upon insertion of the electrical contact 54 of the second component 14 into the open longitudinal end 20a of the first component 12. Referring to FIGS. 8 and 10, a portion of the body 50 surrounding the electrical contact 54 of the second component 14 has clearance grooves 71 for receiving the retaining tabs 40. The clearance groove 71 are sized and shaped such that the retaining tabs 40 remain in the retaining position upon insertion of the electrical contact 54 into the open longitudinal end 20a of the first component 12. Other ways of maintaining the retaining tabs 40 in the retaining position when the first component 12 is connected to the second component 14 do not depart from the scope of the present invention. In a non-limiting example, the electrical contact 54 and/or the portion of the body 50 surrounding the electrical contact may have a diameter smaller than the diameter of the ferrule terminal 18.

In another embodiment, the retaining tabs 40 may deflect into the non-retaining position during insertion of the electrical contact 54 of the second component 14 into the open longitudinal end 20a of the first component 12. In this embodiment, it may be desirable that the retaining tabs 40 be resiliently biased in the retaining position such that the tabs rebound or reflect back into the retaining position upon disconnection of the first and second component 12, 14, respectively, and upon withdrawal of the electrical contact 54 from the interior space 22 of the first component. Other configurations are possible and would not depart from the scope of the present invention.

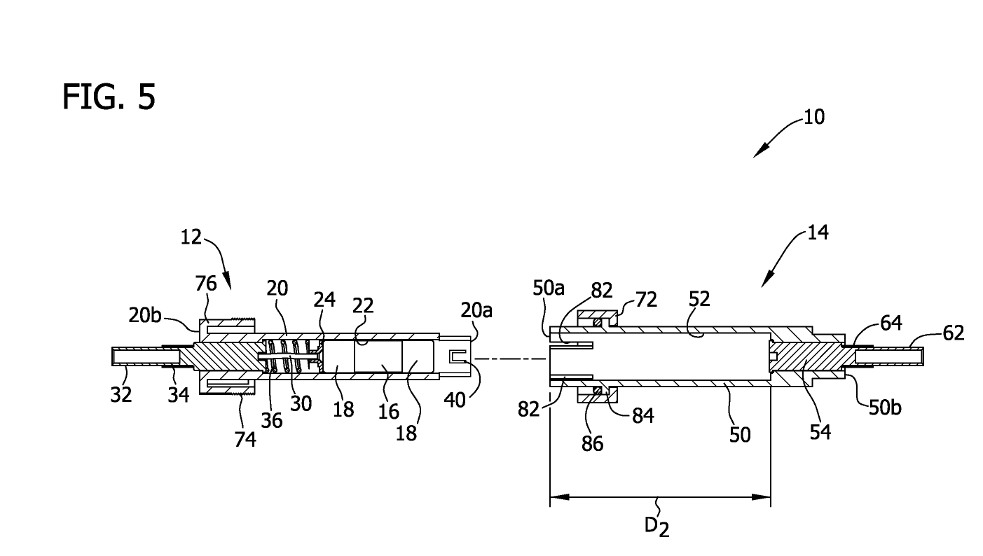

In one example, the open longitudinal end 50a has an inner diameter that is greater than or equal to 12 mm. In this example, the longitudinal distance D₂ (FIG. 5) between the open longitudinal end 50a of the body 50 and the electrical contact 54 is greater than 80 mm. Accordingly, the second component 14 is IP 20 compliant and finger-safe according to the International Electrotechnical Commission (IEC). In another example, where the inner diameter at the open longitudinal end 50a is less than 12 mm, the longitudinal distance between the open longitudinal end 50a of the body 50 and the electrical contact 54 does not have to be greater than 80 mm (although it may be) in order to be IP 20 compliant.

In the illustrated embodiment, the first and second components 12, 14 are releasably connectable to one another by a compression nut 72 on the second component 14 that threads onto exterior threads 74 of a coupler 76 on the first component 12. It is understood that the first and second components 12, 14 of the fuse holder assembly 10 may be releasably connectable to one another in other ways, such as by snap-fit connection or press-fit connection.

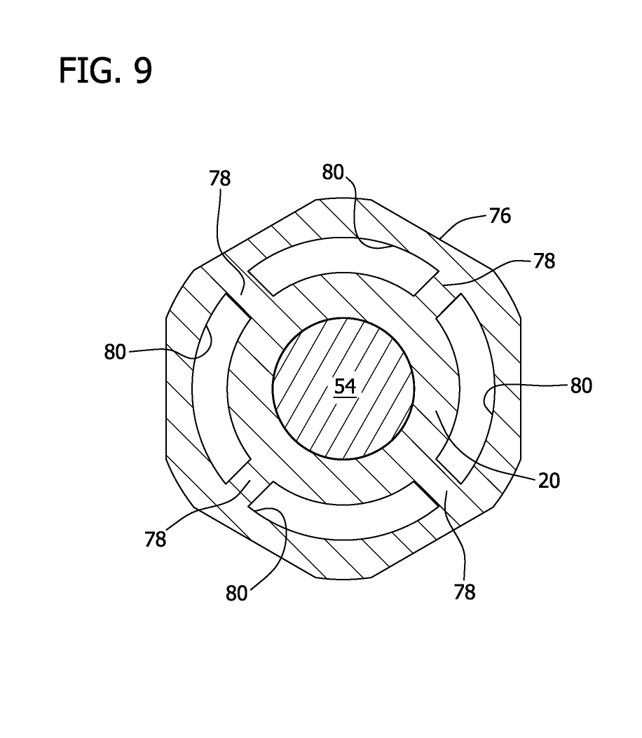

Referring to FIGS. 4, 5 and 7, the coupler 76 of the illustrated embodiment surrounds a portion of the body 20 of the first component 12 generally adjacent to the closed longitudinal end 20b. Internal radial ribs 78 of the coupler 76 (FIG. 9) are secured to the body 20 and a spaced apart circumferentially about the body to define arcuate clearance slots 80 extending around circumferential portions of the body. When the first component 12 is inserted in the second component 14, the radial ribs 78 pass into clearance slots 82 (FIGS. 2, 5, and 7) extending longitudinally from the open longitudinal end 50a of the second component, and the open longitudinal end 50a of the second component 14 passes into the clearance slots 80 of the coupler 76. The compression nut 72 of the illustrated embodiment surrounds and is rotatable about a portion of the second component 14 generally adjacent to the open longitudinal end 50a. A flange 84 extending radially or laterally outward from the second component 14 facilitates positioning of the compression nut 72 of the second component. An O-ring or gasket 86 abuts the flange 84 and is sandwiched between the flange and an end of the coupler 76 when the compression nut 72 is threaded on the coupler 76 to form a waterproof seal that inhibits the ingress of water and other liquid into the interior spaces 22, 52.

In a non-limiting example of an installation method, the safety fuse holder assembly 10 is electrically connected to an electrical system by connecting wires or cables or other conductors of the system to the electrical connectors 32, 64 of the respective first and second components 12, 14. In one example, the line side of the electrical system is connected to the first component 12, and the load side of the electrical system is connected to the second component 14. In effect, the wires or cables or other conductors of the electrical system are secured directly to the safety fuse holder assembly 10 so that the fuse holder assembly is built into a line of the electrical system. With the first and second components 12, 14 of the fuse holder assembly 10 separated (i.e., the fuse holder assembly is open), the fuse 16 is inserted through the open longitudinal end 20a and into interior space 22 of the first component. In one example, the entirety of the fuse 16 is slid past the retaining tabs 40, and then the retaining tabs are positioned (e.g., pivoted) into the retaining position using a finger or a tool. This exemplary method may be suitable where the retaining tabs 40 are not biased or urged in the retaining position. In another example, a portion of the fuse 16 is slid past the retaining tabs 40, and the retaining tabs 40 hold the fuse in that position. This exemplary method may be suitable where the retaining tabs are biased or urged in the retaining position.

After inserting, at least partially, the fuse 16 into the first component 12, the first component is inserted into the interior space 52 of the second component. Where the fuse 16 is only partially inserted in the first component before inserting the first component 12 into the second component 14, the electrical contact 54 in the second component 14 will force the fuse past the retaining tabs 40, whereby the retaining tabs may reflect to the retaining position if the tabs are resiliently biased in the retaining position and there is clearance for tabs to reflect. After inserting the first component 12 into the second component 14, the components are connected together by threading the compression nut 72 onto the coupler 76, for example. When the first and second components 12, 14 are connected, the fuse 16 is electrically connected within the electrical system.

When it becomes necessary to check and/or replace the fuse 16 in the fuse holder assembly 10, a maintenance method may be employed. In an exemplary maintenance method, the first and second component 12, 14 are disconnected, such as by unthreading the compression nut 72 from the coupler 76. (It is contemplated that fuse holder assembly 10 may be configured to allow a technician to determine the state of the fuse 16 without requiring the fuse to be removed from the fuse holder assembly.) The first component 12 is then withdrawn from the second component 14. During withdrawal, the entirety of the fuse 16 remains in the interior space 22 of the first component 12. Thus, the safety fuse holder assembly 10 allows a technician or other person to open the fuse holder assembly and check the state of the fuse 16 during normal operation and/or troubleshooting, without apprehension of inadvertently contacting one of the electrical terminals 18 of the fuse 16 and experiencing an electrical shock.

In the example of the fuse holder assembly 10 where the open longitudinal end 20a of the first component has an inner diameter that is less than 12 mm, and the linear clearance slots 80 in the first component have dimension (i.e., lengths and widths) less than 12 mm, the first component is IP20 compliant and finger-safe according to the International Electrotechnical Commission (IEC). Moreover, where the distance D₂ between the open longitudinal end 50a and the electrical contact 54 of the second component 14 is greater than 80 mm, the second component is also IP20 compliant and finger-safe according to the International Electrotechnical Commission (IEC). Thus, a fuse holder assembly 10 including both of these examples of the first and second components 12, 14, respectively, is IP20 compliant and finger-safe according to the International Electrotechnical Commission (IEC).

A safety fuse holder assembly has been disclosed. The safety fuse holder includes a first fuse holder component, and second fuse holder component, and a retaining member on the first fuse holder component. The first fuse holder component includes a body having a first open longitudinal end and defining a first interior space extending longitudinally from the first open longitudinal end. The first open longitudinal end and the first interior space are sized and shaped to allow insertion of a fuse through the first open longitudinal end and into the first interior space such that an entirety of the fuse is received in the first interior space. The second fuse holder component includes a body having a second open longitudinal end and defining a second interior space extending longitudinally from the second open longitudinal end. The second open longitudinal end and the second interior space are sized and shaped to allow insertion of at least a longitudinal portion of the body of the first fuse holder component through the second open longitudinal end and into the second interior space. The retaining member is selectively configurable to retain the fuse in the first interior space of the first fuse holder component such that the entirety of the fuse remains in the first interior space when the first fuse holder component is removed from the second fuse holder component.

Optionally, an inner diameter of the first open longitudinal end may be less than 12 mm. The retaining member may also be positionable between a retaining position, in which the retaining member is configured to retain the fuse in the first interior space of the first fuse holder component, and a non-retaining position, in which the retaining member is configured to allow the fuse to move out of the first interior space of the first fuse holder component. The retaining member may also be laterally deflectable relative to the first fuse holder component to position the retaining member between the non-retaining position and the retaining position. The retaining member may be resiliently biased in the retaining position. Alternatively, the retaining member may be resiliently deflectable into the non-retaining position as the fuse is being inserted into the first interior space of the first component. The retaining member may include at least one retaining tab, wherein the retaining tab is formed integrally with the body of the first fuse holder component and hingedly secured thereto by a living hinge. The retaining member may be configured to selectively retain the fuse in the first interior space of the first fuse holder component such that a ferrule terminal of the fuse adjacent to the first open longitudinal end is spaced a distance from the first open longitudinal end that is greater than about 1 mm (0.04 in).

In addition, the first and second fuse holder components may further include electrical contacts in the respective first and second interior spaces. The electrical contacts may be configured to make electrical connections with respective ferrule terminals of the fuse when the fuse is received in the first interior space and the first fuse. The first and second fuse holder components may further include electrical connectors electrically connected to the respective electrical contacts. The electrical connectors may be configured for electrically connection to conductors of an electrical system. A distance between the second open longitudinal end and the electrical contact of the second fuse holder component may be greater than 80 mm.

Moreover, the first fuse holder component may include a first connection member adjacent to a longitudinal end of the body of the first fuse holder component opposite the first open longitudinal end. The second fuse holder component may include a second connection member adjacent to the second open longitudinal end. The first and second connection members may be configured for releasable attachment to one another when the first fuse holder component is inserted into the second interior space of the second fuse holder component. One of the first and second connection members may include a compression nut.

In another embodiment, a safety fuse holder assembly includes a first fuse holder component, a second fuse holder component, and an electrical contact in the second fuse holder component. The first fuse holder component includes a body having a first open longitudinal end and defining a first interior space extending longitudinally from the first open longitudinal end. The first open longitudinal end and the first interior space are sized and shaped to allow insertion of a fuse through the first open longitudinal end and into the first interior space such that an entirety of the fuse is received in the first interior space. The second fuse holder component includes a body having a second open longitudinal end and defining a second interior space extending longitudinally from the second open longitudinal end. The second open longitudinal end and the second interior space are sized and shaped to allow insertion of at least a longitudinal portion of the body of the first fuse holder component through the second open longitudinal end and into the second interior space of the second fuse holder component. The electrical contact is in the second interior space of the body of the second fuse holder component. The electrical contact is configured for insertion through the first open longitudinal end and into the first interior space of the first fuser holder component to make electrical connection with the fuse when the fuse is received in the first interior space and the first fuse holder component is inserted into the second interior space of the second fuse holder component.

Optionally, a longitudinal distance between the second open longitudinal end and the electrical contact may be greater than 80 mm. The safety fuse holder assembly may further include a retaining member on the first fuse holder component. The retaining member may be configured to selectively retain the fuse in the first interior space when the first fuse holder component is removed from the second fuse holder component. An inner diameter of the first open longitudinal end may be less than 12 mm.

In addition, the first fuse holder component may include a first connection member adjacent to a longitudinal end of the body of the first fuse holder component opposite the first open longitudinal end. The second fuse holder component may include a second connection member adjacent to the second open longitudinal end. The first and second connection members may be configured for releasable attachment to one another when the first fuse holder component is inserted into the second interior space of the second fuse holder component. One of the first and second connection members may include a compression nut.

In yet another embodiment, a method of installing a ferrule fuse in an electrical system includes: electrically connecting a safety fuse holder assembly to the electrical system, wherein the safety fuse holder assembly includes releasably attachable first and second fuse holder components having respective electrical contacts; inserting the ferrule fuse through a first open longitudinal end of the first fuse holder component and into a first interior space of the first fuse holder component such that an entirety of the ferrule fuse is received in the first interior space, wherein the first open longitudinal end has an inner diameter that is less than 12 mm; moving a retaining member on the first fuse holder component into a retaining position, whereby the retaining member is configured to retain the entirety of the ferrule fuse in the first interior space of the first fuse holder component; and attaching the first fuse holder component to the second fuse holder component such that opposite ferrule terminals of the ferrule fuse are in electrical contact with the respective electrical contacts of the first and second fuse holder components.

Optionally, the step of attaching the first fuse holder component to the second fuse holder component may include inserting the first fuse holder component through a second open longitudinal end of the second fuse holder component and into a second interior space of the second fuse holder component. A longitudinal distance between the second open longitudinal end of the second fuse holder component and the electrical contact of the second fuse holder component may be greater than 80 mm.

In another embodiment, a method of performing maintenance on an electrical system includes: disconnecting first and second fuse holder components of a safety fuse holder assembly, wherein the safety fuse holder encloses a ferrule fuse that is electrically connected to the electrical system; and retaining an entirety of the ferrule fuse in a first interior space of the first fuse holder component upon said disconnecting first and second fuse holder components, wherein the first fuse holder component has an open longitudinal end leading to the first interior space, the open longitudinal end having an inner diameter that is less than 12 mm.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A safety fuse holder assembly comprising:
a first fuse holder component including a body having a first open longitudinal end and defining a first interior space extending longitudinally from the first open longitudinal end, wherein the first open longitudinal end and the first interior space are sized and shaped to allow insertion of a fuse through the first open longitudinal end and into the first interior space such that an entirety of the fuse is received in the first interior space;
a second fuse holder component including a body having a second open longitudinal end and defining a second interior space extending longitudinally from the second open longitudinal end, wherein the second open longitudinal end and the second interior space are sized and shaped to allow insertion of at least a longitudinal portion of the body of the first fuse holder component through the second open longitudinal end and into the second interior space; and
a retaining member on the first fuse holder component, wherein the retaining member is selectively configurable to retain the fuse in the first interior space of the first fuse holder component such that the entirety of the fuse remains in the first interior space when the first fuse holder component is removed from the second fuse holder component.

2. The safety fuse holder assembly set forth in claim 1, wherein an inner diameter of the first open longitudinal end is less than 12 mm.

3. The safety fuse holder assembly set forth in claim 2, wherein the retaining member is positionable between a retaining position, in which the retaining member is configured to retain the fuse in the first interior space of the first fuse holder component, and a non-retaining position, in which the retaining member is configured to allow the fuse to move out of the first interior space of the first fuse holder component.

4. The safety fuse holder assembly set forth in claim 3, wherein the retaining member is laterally deflectable relative to the first fuse holder component to position the retaining member between the non-retaining position and the retaining position.

5. The safety fuse holder assembly set forth in claim 3, wherein the retaining member is resiliently biased in the retaining position.

6. The safety fuse holder assembly set forth in claim 5, wherein the retaining member is resiliently deflectable into the non-retaining position as the fuse is being inserted into the first interior space of the first component.

7. The safety fuse holder assembly set forth in claim 2, wherein the retaining member comprises at least one retaining tab, wherein the retaining tab is formed integrally with the body of the first fuse holder component and hingedly secured thereto by a living hinge.

8. The safety fuse holder assembly set forth in claim 1, wherein the retaining member is configured to selectively retain the fuse in the first interior space of the first fuse holder component such that a ferrule terminal of the fuse adjacent to the first open longitudinal end is spaced a distance from the first open longitudinal end that is greater than about 1 mm (0.04 in).

9. The safety fuse holder assembly set forth in claim 2, wherein the first and second fuse holder components further include electrical contacts in the respective first and second interior spaces, the electrical contacts configured to make electrical connections with respective ferrule terminals of the fuse when the fuse is received in the first interior space and the first fuse holder component is received in the second interior space.

10. The safety fuse holder assembly set forth in claim 9, wherein the first and second fuse holder components further include electrical connectors electrically connected to the respective electrical contacts, the electrical connectors being configured for electrically connection to conductors of an electrical system.

11. The safety fuse holder assembly set forth in claim 9, wherein a distance between the second open longitudinal end and the electrical contact of the second fuse holder component is greater than 80 mm.

12. The safety fuse holder assembly set forth in claim 1, wherein the first fuse holder component includes a first connection member adjacent to a longitudinal end of the body of the first fuse holder component opposite the first open longitudinal end, wherein the second fuse holder component includes a second connection member adjacent to the second open longitudinal end, wherein the first and second connection members are configured for releasable attachment to one another when the first fuse holder component is inserted into the second interior space of the second fuse holder component.

13. The safety fuse holder assembly set forth in claim 12, wherein one of the first and second connection members comprises a compression nut.

14. A safety fuse holder assembly comprising:
a first fuse holder component including a body having a first open longitudinal end and defining a first interior space extending longitudinally from the first open longitudinal end, wherein the first open longitudinal end and the first interior space are sized and shaped to allow insertion of a fuse through the first open longitudinal end and into the first interior space such that an entirety of the fuse is received in the first interior space;
a second fuse holder component including a body having a second open longitudinal end and defining a second interior space extending longitudinally from the second open longitudinal end, wherein the second open longitudinal end and the second interior space are sized and shaped to allow insertion of at least a longitudinal portion of the body of the first fuse holder component through the second open longitudinal end and into the second interior space of the second fuse holder component; and
an electrical contact in the second interior space of the body of the second fuse holder component, the electrical contact configured for insertion through the first open longitudinal end and into the first interior space of the first fuser holder component to make electrical connection with the fuse when the fuse is received in the first interior space and the first fuse holder component is inserted into the second interior space of the second fuse holder component.

15. The safety fuse holder assembly set forth in claim 14, wherein a longitudinal distance between the second open longitudinal end and the electrical contact is greater than 80 mm.

16. The safety fuse holder assembly set forth in claim 15, further comprising a retaining member on the first fuse holder component, wherein the retaining member is configured to selectively retain the fuse in the first interior space when the first fuse holder component is removed from the second fuse holder component

17. The safety fuse holder assembly set forth in claim 16, wherein an inner diameter of the first open longitudinal end is less than 12 mm.

18. The safety fuse holder assembly set forth in claim 14, wherein the first fuse holder component includes a first connection member adjacent to a longitudinal end of the body of the first fuse holder component opposite the first open longitudinal end, wherein the second fuse holder component includes a second connection member adjacent to the second open longitudinal end, wherein the first and second connection members are configured for releasable attachment to one another when the first fuse holder component is inserted into the second interior space of the second fuse holder component.

19. The safety fuse holder assembly set forth in claim 18, wherein one of the first and second connection members comprises a compression nut.

20. A method of installing a ferrule fuse in an electrical system, the method comprising:
electrically connecting a safety fuse holder assembly to the electrical system, wherein the safety fuse holder assembly includes releasably attachable first and second fuse holder components having respective electrical contacts;
inserting the ferrule fuse through a first open longitudinal end of the first fuse holder component and into a first interior space of the first fuse holder component such that an entirety of the ferrule fuse is received in the first interior space, wherein the first open longitudinal end has an inner diameter that is less than 12 mm;
moving a retaining member on the first fuse holder component into a retaining position, whereby the retaining member is configured to retain the entirety of the ferrule fuse in the first interior space of the first fuse holder component; and
attaching the first fuse holder component to the second fuse holder component such that opposite ferrule terminals of the ferrule fuse are in electrical contact with the respective electrical contacts of the first and second fuse holder components.

21. The method set forth in claim 20 wherein said attaching the first fuse holder component to the second fuse holder component comprises inserting the first fuse holder component through a second open longitudinal end of the second fuse holder component and into a second interior space of the second fuse holder component.

22. The method set forth in claim 21 wherein a longitudinal distance between the second open longitudinal end of the second fuse holder component and the electrical contact of the second fuse holder component is greater than 80 mm.

23. A method of performing maintenance on an electrical system, the method comprising:
disconnecting first and second fuse holder components of a safety fuse holder assembly, wherein the safety fuse holder encloses a ferrule fuse that is electrically connected to the electrical system; and
retaining an entirety of the ferrule fuse in a first interior space of the first fuse holder component upon said disconnecting first and second fuse holder components, wherein the first fuse holder component has an open longitudinal end leading to the first interior space, the open longitudinal end having an inner diameter that is less than 12 mm.
